(19) United States
(12) Patent Application Publication
(10) Pub. No.: US 2002/0147823 A1
(43) Pub. Date: Oct. 10, 2002

(54) Computer network system

(75) Inventor: Robert Healy, Stillorgan (IE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Eland Technologies Inc.

(21) Appl. No.: 09/795,725

(22) Filed: Feb. 28, 2001

(30) Foreign Application Priority Data
Jan. 29, 2001 (IE) S2001/0064

(51) Int. Cl. G06F 15/16; G06F 15/173

(52) U.S. Cl. 709/230; 709/243

(57) ABSTRACT

A computer network comprises a plurality of hosts and a plurality of hubs, in which each host can communicate with a hub through a connection service using one or more host protocols. Each hub executes a relay service to exchange data with at least one other hub using a hub protocol, in which network a service controller operates to determine dynamically which hub executes a service in response to a request form a service from a host. Thus, the network is not dependent upon the operation of a single hub; and the service controller can cause a connection service to operate on a selected one of a plurality of hubs in dependence upon loading and/or availability.

### FIELD OF THE INVENTION

This invention relates to a computer network system.

### BACKGROUND OF THE INVENTION

When connecting multiple computer host computer systems, particularly, but not exclusively mainframe host systems, two mechanisms are typically used. These are referred to as:

Bilateral connection

Hub-based connection

In the case of bilateral connection, represented in FIG. 2 each host is connected to and must become aware of every other host and have specific functionality to handle every other host at an application level. At a network level, when hosts have different protocols or access mechanisms one, other or both hosts have to include functionality to handle each of the other's protocols.

This type of configuration is generally manageable where there are just two hosts. However, it becomes difficult when there are three or four hosts, and can be impossible to manage or implement for more than five hosts.

In the case of a hub-based connection, represented in FIG. 2, each host is connected to a hub. At the application level, each host only need be aware of the hub. For example, when an application logic requests data, the host must decide if the data is local (for example, in an existing local database) or remote (accessed through the hub). No matter how many hosts are subsequently added to the hub, this application level logic never need changed once put in place.

At the network level, the hub must have protocol support for each host that is connected to it. This type of protocol support for most mainframe systems already exists in available hubs, for example, Runway Open Server from Eland Technologies Limited, Ireland, and can be easily extended for new mainframe systems. However, this configuration has a significant weakness in that failure of the hub can result in failure of the entire network.

### SUMMARY OF THE INVENTION

According to the present invention there is, from a first aspect, provided a computer network comprising a plurality of hosts and a plurality of hubs, in which each host can communicate with a hub through a connection service using one or more host protocols, and each hub executes a relay service to exchange data with at least one other hub using a hub protocol, in which network a service controller operates to determine dynamically which hub executes a service in response to a request form a service from a host.

Thus, the network is not dependent upon the operation of a single hub; the service controller can cause a connection service to operate on a selected one of a plurality of hubs in dependence upon loading and/or availability.

The connection service typically provides a hub with support for the connection protocols for a host.

Typically, the service controller of a hub is operative to communicate with the service controller of one or more other hubs to determine status information relating to the or each other hub. More particularly, the service controller is advantageously operative to base its determination of which hub is to operate a connection service upon status information received from one or more other hubs.

In typical embodiments, the service controller of a hub can request instantiation of a process on another hub. The process may be an application or a network service. Moreover, the service controller can send to the other hub a description of one or more hosts in order that the connection service of the other hub can communicate with the hosts concerned. In order to provide a robust network, upon failure of a service on a first hub, the hub may request instantiation of an instance of the service on a second hub. Advantageously, the service instance instantiated on the second hub provides services to an application executing on a host connected to the first hub. Thus, when a service on a local hub is subject to failure, the service can be provided by a remote hub.

In an advantageous configuration, each hub is associated with a buddy hub, the buddy hub operating to monitor its status and provide replacement services upon failure of the hub.

Operation of each host may be defined by a configuration file, each host having an identical configuration file. This can simplify tasks that make changes to the network, such as adding and removing hosts.

Most typically, data is exchanged between hubs of a network embodying the invention using a common protocol. The protocol may comprise messages encoded in extensible mark-up language (XML).

Data is typically exchanged between each hub and a connected host using a protocol that is specific to the host. This ensures that the presence in the network appear of other protocols is not apparent to an application executing on the host.

From a second aspect, the invention provides a hub for use in a computer network comprising a connection services layer that exchanges data with one or more hosts and a relay services layer that communicates with services on one or more hubs.

In such a hub, the relay services layer transports a service request from an application executing on a host to a service provider process executing on a hub. In a normal condition, the relay services layer and the service provider process execute on the same hub. Alternatively, the relay services layer and the service provider process may operate on two remote interconnected hubs.

A hub embodying this aspect of the invention may include a mapping layer that operates to transform data between a protocol for exchanging data with a host and a common protocol to exchange data with another hub.

From a third aspect, the invention provides a method of operating a computer network that comprises a plurality of hosts and a plurality of hubs, in which each host communicates with a hub through a connection service using one or more host protocols, and each hub executes a relay service to exchange data with at least one other hub using a hub protocol, in which network a service controller determines dynamically which hub executes a service in response to a request form a host.

Most advantageously, upon failure of a service on a first host, the relay service forwards a request for a service to another hub. This failover process ensures an application continues to have its requests handled in the event of a local failure.

In the event of detection of failure a service on a hub, a request may sent to another hub to instantiate an instance of the failed service. This may be necessary if the service is not already executing on the remote hub.

It may be that the request is made by the hub on which the service has failed.

However, if this is not possible (for example, because the hub has completely failed) the request may be made by another hub that operates to monitor the status of services operating on the hub.

Advantageously, after a predetermined time interval, an attempt may be made to re-start the failed service on the host. This failback process ensures that a service is automatically resumed to a normal condition after a failure has been rectified. Then, subsequent requests for the service may be handled by the hub.

### BRIEF DESCRIPTION OF THE DRAWINGS

Having thus described the invention in general terms, reference will now be made to the accompanying drawings, which are not necessarily drawn to scale, and wherein:

An embodiment of the invention will now be described in detail with reference to the accompanying drawings, in which:

FIG. 1 is a representation of the networks of mainframe computers connected in bilateral networks, and has already been discussed;

FIG. 2 is a representation of a network of mainframe computers connected in a hub-based network, and has already been discussed;

FIG. 3 illustrates a network of computer systems, together constituting an air travel booking and reservation system embodying the invention;

FIG. 4 is a representation of a plurality of hosts and a hub in a network being an embodiment of the invention;

FIGS. 5a, 5b and 5c are representations of networks embodying the invention that have, respectively, a monolithic, a highly distributed, and an intermediate configuration;

FIG. 6 illustrates the interconnection between a service controller, and associated hosts, in a network embodying the invention;

FIG. 7 illustrates interconnection between hubs in a network embodying the invention;

FIG. 8 illustrates the components and operation of a relay service being a component of a hub in a network embodying the invention;

FIG. 9 illustrates movement of data in a network embodying the invention from the point of view of a host;

FIG. 10 illustrates sending and responding to queries by a host in a network embodying the invention;

FIG. 11 illustrates an architecture where multiple hosts are connected to a single hub in a network embodying the invention;

FIG. 12 illustrates data flow through a single hub, as illustrated in FIG. 11;

FIG. 13 illustrates a multiplicity of relay service processes executing to serve multiple hosts connected to a hub in a network embodying the invention;

FIG. 14 is a flowchart of a listening stage of a relay service in a hub of a network embodying the invention;

FIG. 15 illustrates a configuration file for use in an embodiment of the invention; and

FIG. 16 illustrates interconnection between hubs on a network embodying the invention.

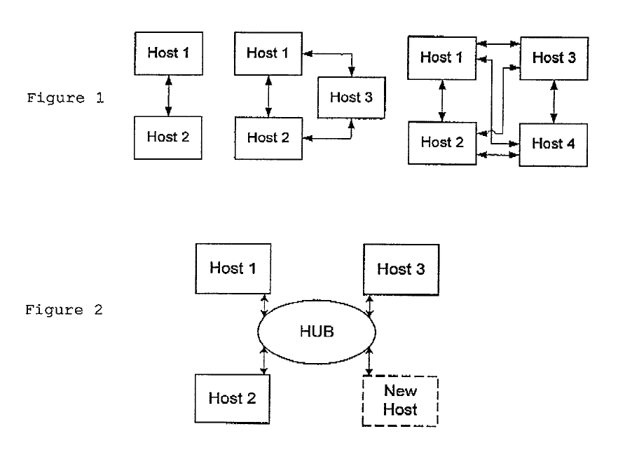

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

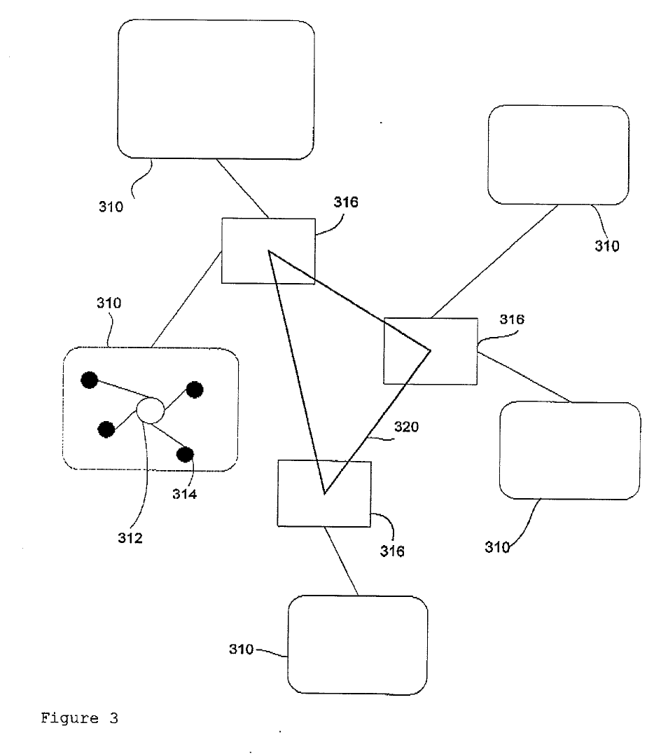

This embodiment of the invention is constituted by a hub-based network, illustrated generally in FIG. 3. The clients in this example network are reservation systems maintained by airline companies, and may thus be distributed over a wide geographical area. Each airline company typically has a hub-based network 310, including a server 312 and a plurality of hosts 314, that uses its own protocols within their network. Each of the company networks 310 is connected to one of a plurality of hubs 316. The hubs 316 are interconnected by suitable wide-area network links 320. Within the network as a whole, these disparate systems must be able to communicate with one another in order to handle a request to make a reservation for a journey that involves travel on flights run by more than one airline.

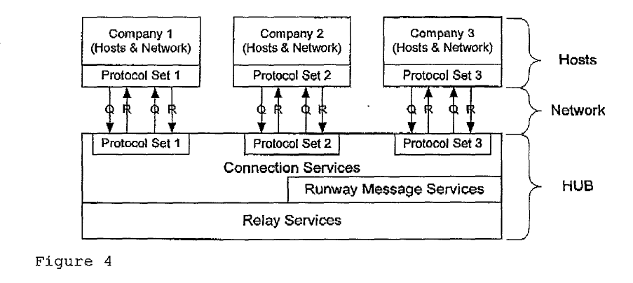

The preferred embodiment of the present invention uses Runway Open Server (described above) as a server at each hub. A hub, and its interconnections, is shown in FIG. 4. The hub comprises many components:

Connection services, which includes support for each host's set of connection protocols;

Message services, at the application layer these make the host functionality and data appear as a generic set of messages; and

Relay services: a component that uses both message and connection services to receive messages from every host and for each message decides based on contents which host to send it to.

Thus, server provides connection and message services and the relay service uses these services like any other client.

As indicated by the arrows in FIG. 4, each company both sends queries (“Q”) to the hub and responding (“R”) to queries form the hub. It is possible to set up any host to respond to queries or send queries only, depending on requirements.

A further component of the embodiment, the service controller, is not shown in FIG. 4, because it does not take part in normal query/response traffic. The function of the service controller is to ensure that, as far as a network client is concerned, hub services continue to be provided even if the hub has suffered a partial failure.

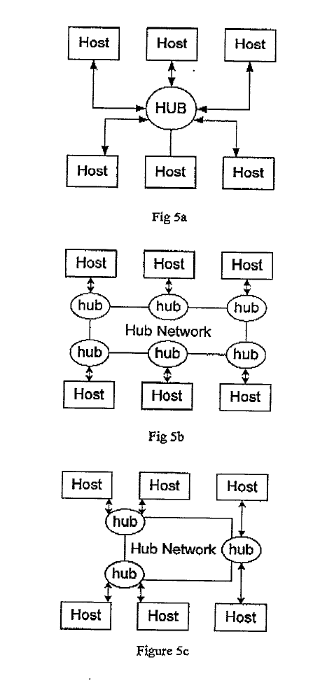

One drawback of the architecture of FIG. 5a is that it is “monolithic”, meaning that no matter how many hosts are present on the network, there is only ever one hub and thus one point at which the entire network of hosts can fail.

However, according to the present invention hub services are distributed over multiple hosts and the relay service is capable of relaying messages to both local and remote servers running on those hosts.

This makes possible a range of architectures ranging from one hub for all hosts, FIG. 5a, to one hub per host, FIG. 5b or an approach balanced somewhere in between, FIG. 5c.

Embodiments of the present invention use the relay service to support all of these architectures through simple configuration settings.

### Relay Service

The purpose of the relay service is to allow hub-based networks to be built using the servers. The relay service enhances the server by providing the logic to receive messages from one host and forward or relay to another host based on the message contents.

### Service Controller

The principal purpose of service controller is to provide hub-based networks with high-availability and resiliency. The service controller is responsible for managing the entire system of hubs (the hub network) and ensuring that it is fully operational. There is one service controller process per hub.

The service controller helps to maintain the availability of a set of distributed application services across multiple machines or hubs. Multiple hubs can be used to build a system or network of services.

The relay service is used to connect multiple host or mainframe systems (such as airline reservation systems) in a host-to-host or business-to-business architecture. In this embodiment, the relay service is an add-on software component for the Runway Open Server platform.

The server itself has the ability to provide a plugable protocol stack and complex message mapping. This alone allows multiple hosts with entirely different access mechanisms to be seen as a single consistent message source. The relay service enhances the server by providing the logic to receive messages from one host and forward or relay to another host based on the message contents.

In a relay service solution there are normally multiple hubs each running multiple processes. The service controller is there to increase the availability and stability of this kind of solution. The service controller runs on each hub and allows the services of the hub network to move from one hub to another in the event of certain hubs or connections going down.

Message and connection services are accessed via an API. The API comes in many forms including C++ headers and libraries, Java classes, Windows ActiveX controls, etc. The API accesses the server itself using TCP/IP sockets.

### Connection Services

Connection services are provided by a connection broker component (or process) and one or more connection provider components (or processes).

A connection provider implements a protocol to a host system. Connection providers may talk to a host system directly (this is called a low-level connection provider) or via other connection providers (this is called a tunnelling or stacked connection provider). In the travel industry lots of protocols are stacked, e.g. EDIFACT over IATA Host to Host over MATIP (Mapping Airline Traffic over IP).

Together, the connection broker and connection provider are used to implement the connection services.

The connection services offer a simple API for connecting to hosts, sending commands, receiving responses and disconnecting. The API to the connection services facilitate the commands to be summarised below.

### CONNECTION SERVICES API SUMMARY

All API calls translate into TCP/IP socket calls, the details of socket traffic, the server's RPC protocol, are hidden from the caller of the API and are not particularly relevant to the operation of relay service.

Open (virtual host name)

Opens a connection or session to the host system. The virtual host name refers to a section of the system configuration. The API is simple but the hidden complexity of the service is that the broker decides which provider is required and the API then connects to that provider. Returns a SESSION.

Send (SESSION, data)

Sends data to a host session (created by the Open command). The data is an ANSI character string. No protocol-specific packaging is required (headers/trailers, session management, etc.) as this is all provided by the connection providers.

Recv (SESSION)

Receives data from a host session. The data is an ANSI character string as any protocol-specific packaging is removed by the connection providers. Returns data.

Close (SESSION)

Closes a host session.

### Message Services

Message services are provided by the message broker component (or process) and one or more message provider components (or processes).

A message provider implements a message mapping mechanism and uses connection services to talk to a host system.

The purpose of message mapping is to translate a client request in the form of a structured object or extensible mark-up language (XML) into a native command format of a host and to translate the host's response back into a structured object or XML. The structured object, also called a message, is a piece of XML.

Multiple hosts with different command formats can be made to appear identical by suitable design of the XML/Messages. These messages are sometimes called generic format messages. In a multi-host environment they should be a superset of the functionality of the host systems, with the message mapping doing any necessary data conversion (e.g. date formats, code translation, etc.)

Together the message broker and message providers are used to implement the message services and the message services in turn depend on the connection services for actual host access.

The message services offer a simple API for connecting to hosts, sending XML commands, receiving XML responses and disconnecting. The API to the message services facilitates the following commands:

### MESSAGE SERVICES API SUMMARY

All API calls translate into TCP/IP socket calls, the details of socket traffic, the RPC protocol, are hidden from the caller of the API and are not particularly relevant to the operation of the relay service.

Open (virtual host name)

Opens a connection or session to the host system.

The message services pass this command onto the connection services.

Even when using abstract or generic XML to talk to hosts the client application (such as the relay service) needs to be aware of sessions.

Returns a SESSION.

Execute (SESSION, Message)

Message is in XML format.

The message is mapped by the message provider into native host format.

The Send( ) function of the connection services API is called to send data to the host.

The Recv( ) function of the connection services API is called to receive response data from the host.

The response is mapped by the message provider into Message or XML format.

Returns a Message/XML response

Close (SESSION)

Message provider closes a host session using the Close( ) function of the connection services API.

### MP_GENERIC & HMM

MP_GENERIC is an example of a message provider in the server. MP_GENERIC implements a generic mapping description language tool called HMM (Hierarchical Message Mapper). HMM is based on ASCII text files and is easy to write and maintain.

HMM is loaded and used by MP_GENERIC in a dynamic manner (e.g. when it is created or changed there is no need to recompile or even restart MP_GENERIC or other components).

HMM is stored in hmm files (e.g. sabre.hmm) and inside the file there are a set of transactions.

Each transaction comprises an inbound mapping which converts a Query Message (XML) into a native format such as EDIFACT, Sabre SDS (Sabre Structured Distributed Services a data format for communicating with the Sabre GDS (Global Distribution System), etc. and an outbound mapping which converts the native response into a Response Message (XML).

### BINDING API

Before calling either message services or connection services, a client application must bind to a server. Binding is the process of taking a single abstract server group name and with references to a client configuration file resolving it to a physical machine (IP address and ports of message and connection brokers).

Using the BIND API, the details of IP address or domain name and port numbers of the server are hidden from the client.

The BIND API also provides some failover capability but this is normally used in a client/server architecture rather than the host-to-host architecture facilitated by the relay service.

The tasks of the service controller are:

1. Verifying that the components (processes) on its hub are operational.

2. Moving components around the network (to other hubs, for both failover and failback purposes).

3. Keeping track of the location of failed-over components. The following is a list of the network components that may fail:

a. An entire hub

b. An entire hub3 s network access (to other hubs)

c. An application or service process running on a hub

d. A particular Host connection from a hub

e. the service controller Itself

In the service controller Configuration these components are divided into two groups because there are two distinct types of fail-over handling needed required:

1. Services

2. Applications

In a hub-based solution several processes on an individual machine may be talking to each other.

Application processes handle events and drive the system by calling services, for example, the relay service.

Service processes respond to requests. Without application processes to call them they remain quiet. An example of a service would be all of the components of server (either Message services or Connection services)

Applications typically rely on multiple services. When a service is unavailable on a hub all of the applications which use that service must be moved to a hub where the service is available.

The configuration of the service controller tells it which processes are applications and which are services as well as the dependencies between them.

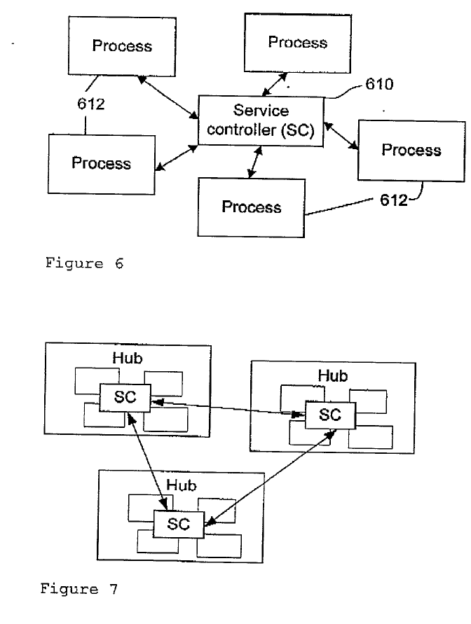

The service controller, as illustrated in FIG. 6, is a process 610 that periodically monitors other processes 612 running on its local hub by sending each one a status request message. When the service controller does not get a return signal from the component (within a configurable time limit) that component is flagged as broken and that component is started up on another hub.

The list of components with which the service controller should communicate, as well as the alternative location of where any component should be started, is determined in the service controller's configuration. At least one secondary hub is listed for each component being monitored, but any number of hubs can be specified.

Each service controller also communicates with other service controllers in other hubs, FIG. 7.

It is the communication between the service controllers that allows services to move between hubs. For example, the service controller on Hub1 can tell the service controller on Hub2 to start the “Sabre FLIFO” service on Hub2. Each service controller can only start processes on its own hub but can communicate to other service controllers to start processes on other hubs.

In the case of a whole hub going down, the service controller on that hub will not be available. If the service controller itself is stopped or crashed, the entire hub is considered to be down and failover all of the applications and services is required.

To detect this, each hub has another hub that is looking out for it—called a “buddy hub”. If a hub discovers its buddy has gone down, it starts up all the services of that failed hub on the appropriate backup hub.

When an individual component goes down the service controller will have to inform all other hubs that a service needs to be moved.

The items that can be restarted/rerouted are:

Routing service (considered an application by service controller)

Components (considered services by service controller)

When a service controller or a whole hub goes down then it involves rerouting multiple relay services and components.

Finally any component that is moved to another hub (“failed over”) eventually should be moved back (“failed back”). For example, the hub might be repaired and restarted, a network connection might become available, and so forth.

Failback is handled by attempting to restart a component on its original hub after a configurable amount of time has elapsed (such as 10 minutes) but not before that.

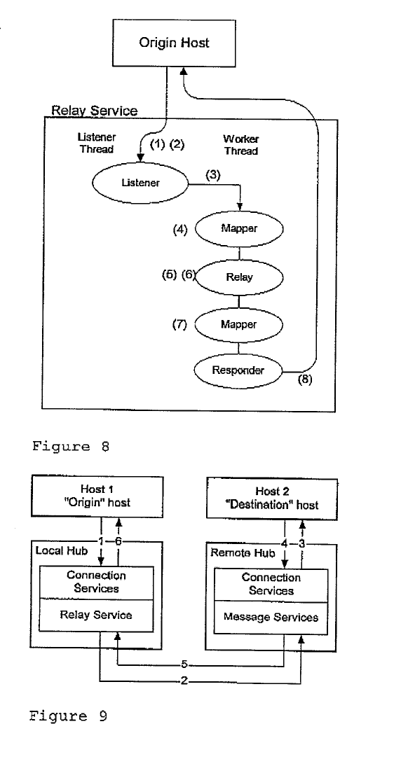

The relay service performs the following steps, shown in FIG. 8, as follows.

1. Open a connection (or session) to an origin host system using connection services API.

2. In a continuous loop, a “listener thread”, listens on this connection for incoming requests. Listening is done by calling the Recv( ) function of the connection services.

3. On receipt of a request Recv( ) returns host data.

The data and the host session are passed as a request to a separate worker thread and the listener thread returns to listening (go to step 1). The listener thread goes to step 1 to allocate a new session after receiving a request from an existing session this is because one session is used for every outstanding request. The worker thread will later use the session to send the response and then free it.

Subsequent steps are then performed by the worker thread:

4. MAP the incoming message from the origin hosts' native request format to a generic format (in this embodiment, XML).

5. Examine the mapped message to determine the target or destination host. The examination is based on a configurable field name and set of values, described later. In any case, since the message is mapped already finding a field is easy.

Finding a service such as a remote server is more complex, for this reason the relay service calls the service controller.

6. Send a request to a destination host (via message services API) and receive a response.

Step 6 encompasses everything that happens on the destination hub, including MP_GENERIC request mapping, connection services sending command and receiving response, and MP_GENERIC response mapping.

7. MAP the response from the generic format (XML) to origin host's native response format.

8. Send s response to the origin host using connection services API and session passed down from listener thread, then close the session.

There are several possible data flows in a multiple host solution.

In a first example, illustrated in FIG. 9, movement and type of data from the point of view of a single host (Host 1, called the originating host) sending queries to one other host (Host 2, called the destination host) is demonstrated.

Every query and response has an origin and destination host.

Referring now to the steps in FIG. 9:

1. Request in the origin host's native format

2. Request in the generic format (request message object XML)

3. Request in the destination host's native format

4. Response in the destination host's native format

5. Response in the generic format (response message object XML)

6. Response in the origin host's native format

In FIGS. 9, message services and connection services are drawn as a single box 910. These services are actually implemented as two APIs used by the relay service and multiple components or processes.

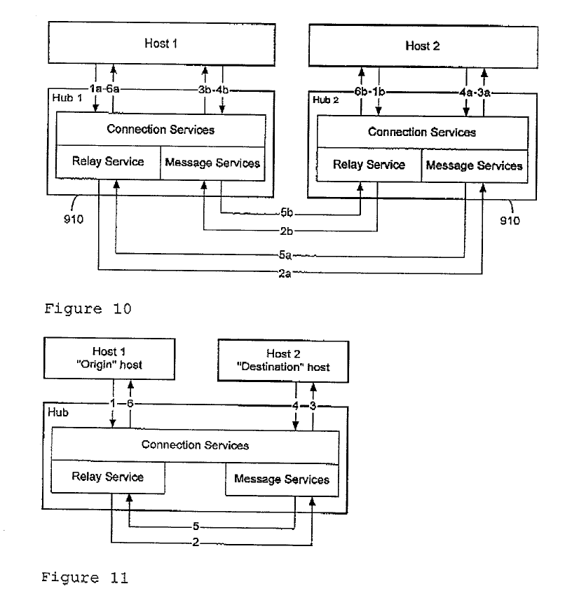

In the example of FIG. 9, Host 1 is the origin host, which sends queries and Host 2 is the destination host, which responds to those queries. In most real-world applications each host will send queries and respond to queries, as illustrated in FIG. 10. In such cases, the relay service is running to receive queries from the origin host on each hub and there is one instance of the relay service for each host sending queries to the hub.

Referring to FIG. 10, items 1a to 6a represent a query from Host 1 to Host 2, where Host 1 is the “Origin” and Host 2 the “Destination” and Hub 1 is the “Local Hub” and Hub 2 is the “Remote Hub”. Items 1b to 6b represent a query from Host 2 to Host 1 where Host 1 is the “Destination” and Host 2 the “Origin” and Hub 1 is the “Remote Hub” and Hub 2 is the “Local Hub”.

FIG. 11, shows an architecture where multiple hosts are connected to a single hub system (as distinct from the dual hub of FIG. 9) and hosts may send requests to other hosts on the same hub. It does not matter if the destination host is on the same hub or a remote hub. As all hubs will support the message services which are used to send requests to the destination host.

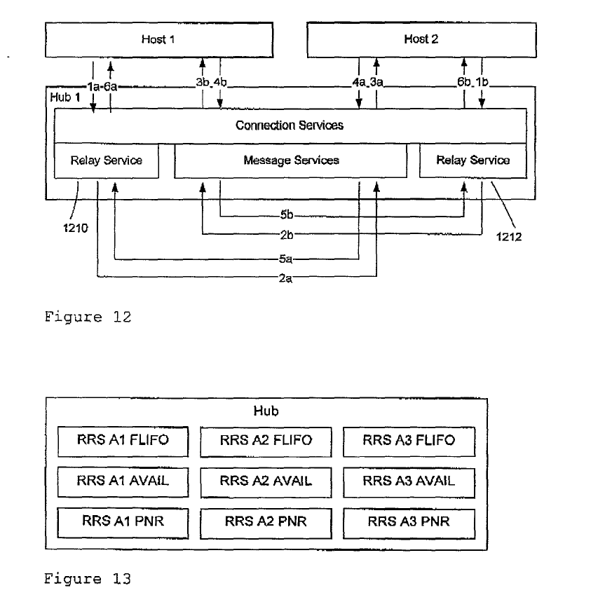

FIG. 12, extends FIG. 11 to show data flow in both directions through a single hub. In FIG. 12, the representation of relay service as two separate boxes 1210, 1212 is intentional. There will be one service per query sending host, so the relay service on the left is the relay service listening to Host 1, and the relay service on the right is relay service listening to Host 2.

Turning now to the thread model in more detail, the thread model of the relay service can be summarized as follows:

1. One relay service process per query sending host

2. One listener thread per relay service process

3. N (configurable) worker threads per relay service process

4. Additionally each application on the sending host can be treated as an entire host (if different network queues/sessions are required for different applications.)

For example, on a hub with four mainframe hosts connected there will be four relay service processes. On a hub with three airlines (A1, A2, A3) and three applications which need to be separate (AVAIL, FLIFO, PNR) there will be nine relay service processes as shown in FIG. 13.

On the other hand, there is one service controller process (or instance) per hub. Each instance of the service controller monitors the other relay service processes and services on the local machine as well as one other service controller process (a “buddy” process) on one remote machine.

In more detail, the relay service performs the following steps:

1. On start up,

Open a connection or session to an origin host system using connection services. The server and the host connection are identified using configurable string values, the server group and the virtual host name. These values are passed to Bind( ) and Open( ) functions in the API. The server (connection services) can be local (same machine) or remote (accessed across a network). However the relay service normally listens to hosts connected to the local machine.

2. In a continuous loop until shut down, listen on this connection for incoming requests.

This is managed as a synchronous call to the connection service API's Recv( ) function. A synchronous call (otherwise known as a blocking call) means that the listener thread in the calling code is stopped until the function returns. This is how most C++ functions and APIs operate, though it is worth mentioning here because some communications packages work in asynchronous mode, which would not handle incoming data as quickly.

This blocking receive mechanism returns data to the relay service as soon as it arrives, the relay service does not have to poll for data, (for example, by calling the Recv( ) function, repeatedly).

3. On receipt of a request, pass request text and the session to a separate worker thread and return to listening (go to step 1).

(The use of a listening thread/worker thread is common in this type of server application.)

This thread model is necessary to ensure that the origin host can have multiple outstanding requests at one time.

There is a configurable maximum number of worker threads so that the system does not get flooded by a particular host. If the all the worker threads are busy the listener thread will not do another blocking receive until one of them is free.

Subsequent steps are performed by the worker thread:

4. Map the incoming message from the origin host's native request format to a generic format or request message object.

If both hosts are using the same data format (e.g. EDIFACT) this step is optional. It is usually necessary because no two hosts are likely to have exactly the same request format even if they both use a common standard such as EDIFACT.

Note: mapping functionality (used here and in step 7) is statically linked to the relay service, it does not call out to message services (mp_generic) to do this. The relay service is built as an integral component and has the same HMM functionality.

5. Examines the message to determine the target or destination host.

This is done based on a configurable field name and a configurable set of values with each value in the configuration identifying a service name.

The service name is used to call the service controller. Based on the service name and the current fail-over state of the hubs the service controller will return the server name and virtual host name to use in the next step.

6. Send a request to the destination host (via message services) and receive a response. Since request will be sent as a request message object (XML) the response will be a response message object (XML).

Step 6 includes everything that happens on the destination Hub including:

(1) mapping of the query into destination format

(2) sending query to destination host

(3) receiving response from destination host; and

(4) mapping the native response back to generic response.

All of this functionality is provided by the message services (mp_generic component and various connection providers for destination host).

7. Map the response from generic format to origin host's native response format.

8. Send the response to the origin host using the connection services API (Send( )) and the session passed in from the listener thread. Then close the session (Close( )).

One instance (or process) of the relay service is run for each host sending queries to the hub. The relay service does not need to be run for hosts that will respond to queries but not send any queries.

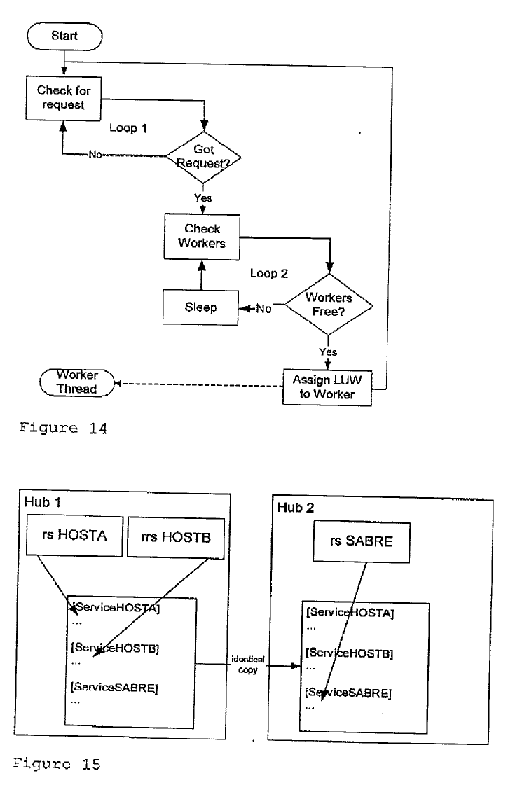

As explained above, after start-up each relay service process goes into a listening stage. FIG. 14 illustrates the listening process in more detail.

1. The “receive from server” step has a configurable timeout value. If no data is received by the server the timeout will expire and no data will be returned. Another sleep will immediately be issued. This is shown as Loop 1 and is the most common processing in a hub application.

Even though the call to the server is a synchronous one (a blocking receive) this loop helps ensure that the relevant component isn't “frozen” and is still operating as normal.

2. Loop 1 can also exit with an error condition (not shown). This is most likely to be where the server returns with a response code other than timeout or 0 (indicating data received).

3. If data is received the maximum allowable threads has to be checked before a new worker thread is created.

If the maximum workers are busy then the second loop (Loop 2, in FIG. 14) will come into effect. This is the throttle loop, which ensures that no new messages are read from the host until there are free resources to handle them.

Loop 2 also has a configurable timeout. This timeout (typically several seconds) indicates a serious error with the relay service and possibly the entire hub, as it means the worker threads are not completing.

In summary: for every host sending queries there will be one relay service. There may be multiple relay services for any host, such as one relay service per application or group of applications. This is because any one host application can be treated as an entire host in its own right. Normally the host protocols dictate a series of application channels (a type of named channel or pipe), so a particular application's queries will always occur over a certain channel. The connection services can be configured to present such an application channel as a single virtual host.

Ideally, hub configuration should be as simple as possible, because a multi-hub environment configuration can otherwise be very difficult to manage. To ease management the relay service is designed to allow identical configuration files to be loaded on all hubs. The relay service does not specify how to move the configuration files between hubs or synchronize configuration changes. The service controller can help manage synchronization but the actual movement of configuration files should be done using tools such as FTP and scripts.

The relay service configuration file is an ASCII text file called rrs.cfg. Like all of the system's configuration files, the rrs.cfg file comprises multiple sections.

Each section is delimited by a line with the section name in square brackets, as in the example below:

[ServiceHOSTA]

[ServiceHOSTB]

[ServiceGDSX]

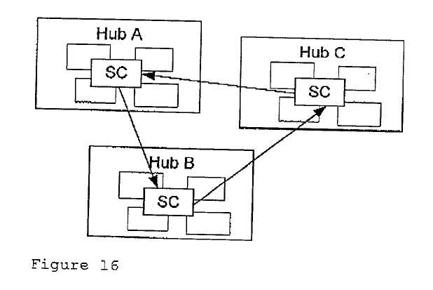

Each service section is named “Service” followed by the service name of the relay service. The example above has three service sections. The three service names are HOSTA, HOSTB and GDSX. When the relay service process is started the first parameter is the service name, e.g. “rrs HOSTA”. In this way the relay service knows which section of the configuration file to read. Provided that services on different hubs are given different names, and because any one instance or process of the relay service only reads one section of the configuration file, the same file can be used on multiple hubs, as illustrated in FIG. 15.

Like all configuration files, rrs.cfg sections comprise lines of name=value pairs. Each name is a setting or configurable item. The values are used to set the behaviour of the relay service. The following names/settings are available in each Service Section of the rrs.cfg file:

Server

This is the server group name used in the Bind( ) call to connect to connection services. This refers to the local server which is used to connect to the host this instance of the relay service will listen to. For example, Server=localRunway

VirtualHostName

This is the virtual host name used in the Open( ) call to in connection services to open a session to the host this instance of the relay service will listen to. For example, VirtualHostName =sabre_flifo.

WorkerThreads

This is the maximum number of worker threads. This prevents flooding from a host system by limiting the number of queries outstanding. When the number of queries outstanding matches the value specified, the Recv( ) function is not called until the at least one of the worker threads completes. For example, WorkerThreads=100.

InboundMapping

The server's mapping capability (and thus the relay service's mapping capability, as it is the same) relies on using HMM files. HMM files to define the mapping logic for converting to and from native formats such as EDIFACT into messages or XML.

This setting refers to a HMM file name and a transaction name separated by a comma. (Each HMM file can comprise multiple “transactions”.) The transaction is the piece of HMM which will convert a native query into the generic query (XML) format. For example, InboundMapping=sabre.hmmflifo_query_in.

OutboundMapping

This setting refers to a HMM file name and a transaction name separated by a comma. The transaction is the piece of HMM which will convert a generic response (XML) into native response format, for example, OutboundMapping=sabre.hmmflifo_response_out.

RelayField

This specifies the name of the field in the generic query format that will be used for routing/relaying decisions. The relay field is used to decide what destination host to send the query to.

In an example involving FLIFO (Flight Information), the relay field might be airline code, as this could be used to find the destination host. So if the query contains a field, Airline=UA we would know that the query is for United Airlines. For example, RelayField=CarrierCode.

RelayTargetN

There can be many RelayTarget settings where N=1, 2, 3, etc. Each value specifies a possible value for the RelayField in the query. After the value, separated by a comma, is the service name. For example:

RelayTarget1 =UA, apollo_ua

RelayTarget2 =AA, sabre_aa

RelayTarget3 =BA,babs

RelayTarget4 =AC,ac_res

The RelayField and RelayTargetN settings are used together so that at run time a particular query (containing “CarrierCode=BA” for example) can be mapped to a service name (“babs” in this case).

The service name is used by the service controller to determine the remote server group and virtual host name used to send the query to the destination node.

In relation to service controller configuration, it should be noted that every service controller will have a local configuration file but that all the configuration files (on every hub) will be identical. The configuration file comprises a general section read by the service controller on each hub as well as several hub specific sections.

The general section allows all the service controllers to share some configuration knowledge such as the “buddy chain” or complete list of service controllers in the network.

The hub specific section contains information on what applications and services should be normally running on the hub as well as the failover hubs. Every process (be it part of an application or part of a service) which may be failed over must be able to respond to the service controller's status request calls.

The service controller periodically calls an RPC (Remote Procedure Call) on the component.

To implement this RPC function a component needs to include a special service controller header file and link with a library, this provides all the TCP/IP communication code needed and allows the component developer to simply implement the

| | |
|---|---|
| RSC_StatusRequest | |
| Called by: | service controller |
| Implemented by: | Every component, relay service |
| Returns: | Currently OK? TRUE or FALSE |
| Purpose: | This is how the service controller knows a |
| | process is still running. If there is no |
| | response or a communications error talking |
| | to the process the service controller assumes |
| | it isn't running. |
| | Also, a running process has a choice of |
| | returning it's state being OK (TRUE) or |
| | BAD (FALSE). This gives the process the |
| | ability to check it's own state and ask to be |
| | failed over. For example, if the process is a |
| | communication process and can detect some |
| | failure (such as a host link being down) |
| | which means that it cannot provide |
| | communication services then it might return |
| | FALSE. |
| | This function detects not only crashed or |
| | inactive processes (which can usually be |
| | done by the OS) but also processes that have |
| | a serious error state. |
| RSC_Stop | |
| Called by: | service controller |
| Implemented by: | Every component, relay service |
| Returns: | no return value |
| Purpose: | The service controller may ask a component |
| | to shut down. The application should stop |
| | accepting new work (e.g. stop listening) and |
| | complete outstanding units of work (e.g. wait |
| | for queries to send responses) within a |
| | certain time frame (normally seconds) before |
| | exiting. |
| | The service controller will only ask a failed |
| | over application or service to stop. It will |
| | only be asked to stop because the service or |
| | application has already been successfully |
| | restarted at the original location. |
| | Some processes, such as the relay service in |
| | a multi-hub network need to know the |
| | current status of the network so they can find |
| | what hub is currently running a particular |
| | service. |
| | The service controller implements an RPC |
| | (Remote Procedure Call) to facilitate the |
| | relay service getting this information. |
| | To call any RPC function on the service |
| | controller a component needs to include a |
| | special service controller header file and link |
| | with a library, this provides all the TCP/IP |
| | communication code needed and allows the |
| | component developer to simply call the |
| | RSC_FindService function. |
| RSC_FindService | |
| Called by: | relay service |
| Implemented by: | service controller |
| Returns: | A Hub name (a character string) |
| Purpose: | The relay service uses this function to find |
| | how to dispatch queries to the destination |
| | host. The relay service passes in the service |
| | name (a character string referring to a |
| | configuration item in service controller |
| | configuration). The hub name returned is |
| | used by the relay service when binding to the |
| | messages services on a remote hub. |
| RSC_NotifyError | |
| Called by: | relay service |
| Implemented by: | service controller |
| Returns: | no return value |
| Purpose: | This function is to allow a component such |
| | as the relay service to notify the service |
| | controller immediately if a serious error is |
| | detected. For example, an error while trying |
| | to listen that indicates the host is not |
| | available. |
| | The effect will be the same as FALSE |
| | returned from RSC_FindService but this |
| | mechanism allows the service controller to |
| | take action more quickly (without waiting for |
| | it to call RSC_FindService). |
| | Every service controller has a service |
| | controller “buddy” which periodically |
| | communicates with it to determine its |
| | availability. As this communication takes the |
| | form of a status request, it means that every |
| | service controller has to be able to respond to |
| | a status request as well as make status |
| | requests. |
| | Referring now to FIG. 16, service controller |
| | components (one per hub) are organized into |
| | chains. In this example: |
| | The service controller on Hub A calls the |
| | service controller on Hub B |
| | The service controller on Hub B calls the |
| | service controller on Hub C |
| | The service controller on Hub C calls the |
| | service controller on Hub A |
| | Thus: |
| | The service controller on Hub A listens for |
| | calls from the service controller on Hub C. |
| | The service controller on Hub B listens for |
| | calls from the service controller on Hub A. |
| | The service controller on Hub C listens for |
| | calls from the service controller on Hub B. |
| | The logical chain above (A −> B −> C) is |
| | actually known about on all hubs, it is part of |
| | the global service controller configuration |
| | file. |
| | If any service controller component starts to |
| | fail the calling service controller will assume |
| | the Hub is down and try and find the next |
| | Hub to talk to, for example,. if B stops |
| | responding to A, A will talk directly to C. |
| RSC_BuddyStatusRequest | |
| Called by: | service controller |
| Implemented by: | service controller |
| Returns: | Currently OK? TRUE or FALSE |
| Purpose: | This is how the service controller knows |
| | another service controller (and hence a hub) |
| | is still running. If there is no response or a |
| | communications error talking to the remote |
| | service controller the service controller |
| | assumes it isn't running (either the service |
| | controller is crashed or the hub is not |
| | available). |
| RSC_FailoverNotify | |
| Called by: | service controller |
| Implemented by: | service controller |
| Returns: | no return value |
| Purpose: | This function is called after a failover |
| | operation has completed. The data passed is |
| | an application or server name and the new |
| | node of that application or server. |
| | RSC_FailoverNotify is called by a service |
| | controller on its buddy service controller. |
| | When an RSC_FailoverNotify is call is |
| | received by a service controller it must |
| | update its data and call the |
| | RSC_FailoverNotify on its buddy in turn. In |
| | this way failover notification moves around |
| | the service controller chain until it returns to |
| | the service controller which performed the |
| | failover. RSC_FailoverNotify is also used to |
| | notify other service controllers when an |
| | application or service fails back. |
| | Not all communication between service |
| | controllers will be via buddy service |
| | controllers. In some cases a service |
| | controller will contact another service |
| | controller directly to failover a process. |
| | All inter-service controller communication is |
| | via TCP/IP. Each service controller is both a |
| | client (caller) and a server (callee). |
| RSC_StartProcess | |
| Called by: | service controller |
| Implemented by: | service controller |
| Returns: | Started OK? TRUE or FALSE. |
| Purpose: | This is the function the service controller |
| | calls to start a component on another hub. |
| | The service controller does not necessarily |
| | call this function on the buddy service |
| | controller, it will call it on the configured |
| | failover hub. The called service controller |
| | will start the component. After the function |
| | the calling service controller will call |
| | RSC_FailoverNotify on the buddy service |
| | controller. This will tell all the service |
| | controllers in the network the new location |
| | of the service or application moved. The |
| | calling service controller will also wait for an |
| | amount of time before retrying the process |
| | locally, it will then send the |
| | RSC_StopProcess command if successful. |
| RSC_StopProcess | |
| Called by: | service controller |
| Implemented by: | service controller |
| Returns: | no return value |
| Purpose: | This is called at the end of the fail-back |
| | process. When the service controller has |
| | successfully restarted a service or application |
| | after a configurable delay (e.g. 10 minutes) it |
| | will call this function on the failover node to |
| | stop the failed over application or service. |

The following is a list of the network components that may fail:

1. An entire hub

2. An entire hub's network access (to other Hubs)

3. An application or service process running on a hub

4. A particular host connection from a hub

5. The service controller itself

If either the Hub is lost or it's network access to other hubs is lost, this appears the same to other hubs. In either case, from the point of view of other hubs a hub has left the network. Also, if a service controller crashes the entire hub is considered lost.

This leaves 3 unique fail-over scenarios:

1. An application or service process running on a hub goes down

2. A Hub or service controller goes down—“Hub Failover”

3. Connectivity to a particular host goes down

An application is configured as primary processes and a number of services. A service, in turn, is configured as a set of processes and possibly dependant services.

An application or service is detected as failed in one of 2 circumstances:

1. A process fails to respond to RSC_StatusRequest or returns FALSE.

2. A process calls RSC_NotifyError on the service controller directly.

When a failure is detected the service controller needs to move the application or service which involves the following steps:

1. Determine the full process list for the application or service

2. For each process:

a) Call the RSC_StartProcess function on the remote node's service controller.

b) For each process failed over send out an update to the other service controllers by calling RSC_FailoverNotify on the buddy node.

c) Wait for the configured “failback” time.

3. Failback each service and application in turn, this involves:

a) Start the process locally

b) If (a) succeeds call RS_StopProcess on the failover hub

c) If (a) fails, wait for a configured “retry” time before repeating (a).

d) If (a) succeeds call RSC_FailoverNotify to update other service controllers on current status.

Hub failure is detected when a service controller calling a buggy service controller using the RSC_BuddyStatusRequest call gets an error or no response from the other service controller.

The service controller needs to do the following steps:

4. Connect to the next service controller in the chain after it's buddy

5. Read the failed hub's configuration to determine the services and applications that need to failover

6. Determine the full process list from the list of applications and services

7. Failover each process in turn, this involves:

(d) If the process's failover hub is the current hub, start locally

(e) If the process's failover hub is remote, call the RSC_StartProcess function on the remote node's service controller.

An application or service might comprise many RSC_StartProcess calls.

(f) For each process failed over send out an update to the other service controllers by calling RSC_FailoverNotify on the buddy node.

(g) Wait for the configured failback time.

(h) Prior to starting failback, the service controller needs to determine if its original buddy is running again or not. It issues another RSC_BuddyStatusRequest, if this fails it returns to step (d), otherwise it starts failback process.

8. Failback each service and application in turn, this involves:

(e) Call RSC_StartProcess on the newly recovered hub. The original hub for this application/process.

(f) If (a) succeeds call RSC_StopProcess on the failover hub.

(g) If (a) fails, wait for a configured retry time before repeating (a).

(h) If (a) succeeds call RSC_FailoverNotify to update other service controllers on current status.

The host connection failure is detected by the relay service, not the service controller directly.

As explained above, the relay service is in a constant listening loop with the connection services. If the connection services return an error, for example, an error indicating that the host is not available there is no point in the relay service trying to listen any more.

In this case the relay service calls the RSC_NotifyError on the local service controller and then exits. Thus, the local service controller is given the job of failing over the relay service which it treats as an application failover/failback scenario.

o-O-o

Embodiments of the invention allows for high performance, and solutions which can be scaled to any number of machines or hubs. The invention allows for high performance (no polling delays), and a high transaction or message throughput rate to be achieved.

Embodiments of the invention allows multiple host systems to be added as well as multiple applications to be supported on those hosts.

Embodiments of the invention also allows multiple hubs to be added as well as multiple applications and services to be supported on each hub.

Using embodiments of the present invention, additional hosts and applications can be added incrementally (one at a time) and without changing code. Also hosts can be removed very easily. A network can be designed around one or a small number of servers/hubs, or a large number of servers/hubs. Additional hubs can be added incrementally (one at a time) and without changing code. Also entire hubs can be removed very easily.

Each hub can contain an identical (heterogeneous) set of services or different (heterogeneous) services.

Hubs in the same system or network can be running different operating systems and different hardware.

Stability is primarily achieved through redundancy. When the network is designed around multiple servers the solution will be available even if some of the servers are not available.

Redundancy is managed by the service controller which moves applications and services from one hub to another hub.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A computer network comprising a plurality of hosts and a plurality of hubs, in which each host can communicate with a hub through a connection service using one or more host protocols, and each hub executes a relay service to exchange data with at least one other hub using a hub protocol, in which network a service controller operates to determine dynamically which hub executes a service in response to a request form a host.

2. A computer network according to claim 1 in which the connection service provides a hub with support for the connection protocols for a host.

3. A computer network according to claim 1 in which the service controller of a hub is operative to communicate with the service controller of one or more other hubs to determine status information relating to the or each other hub.

4. A computer network according to claim 3 in which the service controller is operative to base its determination of which hub is to operate a connection service upon status information received from one or more other hubs.

5. A computer network according to claim 1 in which the service controller of a hub can request instantiation of a process on another hub.

6. A computer network according to claim 5 in which the process is an application.

7. A computer network according to claim 5 in which the process is a network service.

8. A computer network according to claim 5 in which the service controller can send to the other hub a description of one or more hosts in order that the connection service of the other hub can communicate with the hosts concerned.

9. A computer network according to claim 5 in which, upon failure of a service on a first hub, the hub requests instantiation of an instance of the service on a second hub.

10. A computer network according to claim 9 in which the service instance instantiated on the second hub provides services to an application executing on a host connected to the first hub.

11. A computer network according to claim 1 in which each hub is associated with a buddy hub, the buddy hub operating to monitor its status and provide replacement services upon failure of the hub.

12. A computer network according to claim 1 in which operation of each host is defined by a configuration file, each host having an identical configuration file.

13. A computer network according to claim 1 in which data is exchanged between hubs using a common protocol.

14. A computer network according to claim 10 in which the common protocol comprises messages encoded in extensible mark-up language (XML).

15. A computer network according to claim 1 in which data is exchanged between each hub and a connected host using a protocol that is specific to the host.

16. A hub for use in a computer network comprising a connection services layer that exchanges data with one or more hosts and a relay services layer that communicates with services on one or more hubs.

17. A hub according to claim 16 in which the relay services layer transports a service request from an application executing on a host to a service provider process executing on a hub.

18. A hub according to claim 17 in which the relay services layer and the service provider process execute on the same hub.

19. A hub according to claim 17 in which the relay services layer and the service provider process operate on two remote interconnected hubs.

20. A hub according to claim 16 which includes a mapping layer that operates to transform data between a protocol for exchanging data with a host and a common protocol to exchange data with another hub.

21. A method of operating a computer network that comprises a plurality of hosts and a plurality of hubs, in which each host communicates with a hub through a connection service using one or more host protocols, and each hub executes a relay service to exchange data with at least one other hub using a hub protocol, in which network a service controller determines dynamically which hub executes a service in response to a request form a host.

22. A method according to claim 21 in which upon failure of a service on a first host, the relay service forwards a request for a service to another hub.

23. A method according to claim 22 in which, in the event of detection of failure a service on a hub, a request is sent to another hub to instantiate an instance of the failed service.

24. A method according to claim 23 in which the request is made by the hub on which the service has failed.

25. A method according to claim 23 in which the request is made by another hub that operates to monitor the status of services operating on the hub.

26. A method according to claims 23 in which, after a predetermined time interval, an attempt is made to re-start the failed service on the host.

27. A method according to claim 26 in which, if the service is re-started, subsequent requests for the service are handled by the hub.
